(19) United States
(12) Patent Application Publication
(10) Pub. No.: US 2020/0007790 A1
(43) Pub. Date: Jan. 2, 2020

(54) Operating Method for a Camera Display System, Camera Display System, and Vehicle

(71) Applicant: Bayerische Motoren Werke Aktiengesellschaft, Muenchen (DE)

(72) Inventor: Philipp HOFFMANN, Dachau (DE)

(21) Appl. No.: 16/570,236

(22) Filed: Sep. 13, 2019

Related U.S. Application Data
(63) Continuation of application No. PCT/EP2018/055451, filed on Mar. 6, 2018.

(30) Foreign Application Priority Data
Mar. 14, 2017 (DE) 10 2017 204 168.4

(51) Int. Cl. H04N 5/247; B60R 1/02

(52) U.S. Cl. CPC H04N 5/247; B60R 1/02; B60K 2370/84; B60R 2300/8026; B60R 2300/105

(57) ABSTRACT

A camera display system, a vehicle implementing the camera display system, and an operating method for the camera display system are provided. The camera display system includes a camera system with multiple cameras and a display system with one or more displays. Independent images of a surrounding area are captured using the cameras and images of the surrounding area are displayed in a visually combined manner on a display unit. An error status of each of the cameras is detected, and if an error has occurred in a camera, the images of the surrounding area captured by the cameras without errors are displayed in a visually combined manner.

### CROSS REFERENCE TO RELATED APPLICATIONS

This application is a continuation of PCT International Application No. PCT/EP2018/055451, filed Mar. 6, 2018, which claims priority under 35 U.S.C. § 119 from German Patent Application No. 10 2017 204 168.4, filed Mar. 14, 2017, the entire disclosures of which are herein expressly incorporated by reference.

### BACKGROUND AND SUMMARY OF THE INVENTION

The present invention relates to an operating method for a camera display system, in particular for a vehicle, to a camera display system as such, and to a vehicle, in particular a motor vehicle, a passenger car or a truck.

In the field of vehicle technology, in particular in motor vehicles, such as passenger cars and trucks, camera display systems that offer the user a reliable view of the environment of an underlying vehicle in a simple manner are increasingly used to improve comfort and safety. Here, existing mirror systems, for example side mirrors and rearview mirrors are frequently replaced by cameras and monitors. This reduces the movement effort, glance over the shoulder and the like, and also the necessity of having to concentrate on a plurality of points of view.

However, a hitherto unsolved problem in this case is the management of error events, for example, if one or more cameras of the display or parts thereof exhibit defects and a display is defective or fails.

The invention is based on the object of creating an operating method for a camera display system, a camera display system as such, and a vehicle, in which error events are manageable simply and in a reliable fashion and safety standards can be observed.

The object on which the invention is based is achieved in the case of an operating method for a camera display system according to the invention by the features of independent patent claim 1, in the case of a camera display system as such according to the invention by the features of independent patent claim 8, and in the case of a vehicle according to the invention by the features of independent patent claim 10. Advantageous developments are the subject matter of the respective dependent claims.

According to a first aspect of the present invention, an operating method for a camera display system, in particular for a vehicle, is created, wherein the camera display system is embodied with a camera system having a plurality of camera units and with a display system having one or a plurality of display units.

In the operating method according to the invention, camera units are used to capture images of an environment which are independent of one another, in particular in each case in the manner of a sequence of frames, for example, in the manner of a film. Images of the environment are displayed on a display unit, by way of image combination. Furthermore, an error status of camera units is captured. According to the invention, if an error occurs in a camera unit, the images of the environment of camera units without errors are combined into an image and displayed. In this way, it is possible to reliably use image sources which do not exhibit errors.

A particularly high degree of reliability is attained if, according to a preferred embodiment of the operating method according to the invention, the image of a camera unit having errors is overall not taken into account in a display.

However, frequently the error associated with a camera unit is not so grave that the image data generated by the faulty camera unit cannot to be used in a beneficial manner. For example, in accordance with another preferred embodiment, the image of a camera unit having an error is at least partially taken into account for the display. This assumes that the image of the camera exhibiting an error is evaluated using a corresponding evaluation method before it is used.

The camera units employed can be operated in different ways. This also depends on how the individual camera units are positioned and/or oriented in relation to one another.

For example, in another advantageous configuration of the operating method according to the invention, upon capturing images of the environment using one or more camera units, images of the environment are captured with a non-restricted or expanded field of view; in this case, the entire field of view of the respective camera unit is employed during the actual generation of images of the environment.

In addition or alternatively, in another embodiment of the operating method according to the invention, it is possible, when capturing images of the environment using camera units, for images of the environment to be captured with partially overlapping fields of view. This primarily produces somewhat of a redundancy of the image-recorded information, but there are advantages with respect to the safety aspects of the operating method, as will also be described below, because if camera units fail, corresponding overlap regions of other camera units can be used.

Display of the image information recorded by the camera units can be effected differently in a combined manner. In principle, the combined image representation in the manner of separated images is possible, for example in the form of a polyptych—as a generalization of a triptych for three images or a diptych for two images to n images. Alternatively or additionally, it is possible to produce from a plurality of initially separated images what are known as fusion images, in which mutually overlapping regions can be made to coincide by way of algorithms and calculation methods which are known per se so as to produce a common overlaying total image from a plurality of initially separate images of the environment and to display it.

For example, according to another development of the method according to the invention, in the error-free case upon display, images of camera units can be displayed in combination in the manner of a fusion image or in the manner of a polyptych with a number of frames, in particular with restricted field of view, preferably when overlapping fields of view of camera units and/or captured images.

Alternatively or additionally, in the case of an error upon display, images of camera units without errors can be displayed in combination in the manner of a fusion image or in the manner of a polyptych with a correspondingly reduced number of frames, in particular with non-restricted or expanded field of view.

The operating method according to the invention generally reflects the structure and configuration of the camera display system to be operated.

For example, in another development of the operating method according to the invention, in the case of an underlying vehicle, a left external mirror camera can be used as a first camera unit, a right external mirror camera can be used as a second camera unit, and a centrally arranged third camera unit, in particular in the manner of a stereo camera unit having a first and left camera and a second and right camera, and/or a reversing camera unit can be used as an auxiliary camera, in particular in the manner of a fisheye camera and/or in each case with a field of view which is oriented substantially counter to a main driving direction X of the underlying vehicle, as a camera system.

The safety level of the operating method according to the invention can also be useful with respect to the actuation of the display units.

For example, in another development of the operating method according to the invention, in the case of the presence of a plurality of display units, an error status of display units is captured and, upon occurrence of an error in a display unit, a display unit without errors is used for displaying the images, possibly by changing the display unit used, wherein, upon occurrence of an error in all display units, the generation and the outputting of an—in particular acoustic—warning signal is caused or performed, in particular by way of an audio system of the underlying vehicle.

It can furthermore be advantageous if, in accordance with another advantageous development of the operating method according to the invention, in an underlying vehicle, a rearview mirror display is used as a first display unit, a central console display is used as a second display unit, and/or a dashboard display is used as a third display unit as the display system.

Here, generally what is known as a rearview mirror display can be used as a primary display unit, because—in particular in the motor vehicle sector—this matches the viewing habits of a driver.

In accordance with a further aspect of the present invention, a camera display system—in particular for a vehicle—is also proposed.

The camera display system according to the invention is configured with a camera system having a plurality of camera units, with a display system having one or having a plurality of display units, and with a capturing and control unit, which is connected or connectable to the camera system and to the display system via at least one capturing and control line and is adapted to perform the operating method according to the invention.

In an exemplary embodiment of the camera display system according to the invention, the camera system has a left external mirror camera as a first camera unit, a right external mirror camera as a second camera unit, and a centrally arranged third camera unit, in particular in the manner of a stereo camera unit having a first and left camera and a second and right camera, and/or a reversing camera unit can be used as an auxiliary camera, in particular in the manner of a fisheye camera, and/or in each case with a field of view which is oriented substantially counter to a main driving direction X of the underlying vehicle.

Alternatively or additionally, in the camera display system according to the invention, the display system has a rearview mirror display as a first display unit, a central console display as a second display unit, and/or a dashboard display as a third display unit.

In accordance with a further aspect of the present invention, a vehicle, in particular a motor vehicle, a passenger car, or a truck, is also proposed. The vehicle according to the invention is embodied with a camera display system configured according to the invention.

Other objects, details, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically illustrates, in the manner of a block diagram, an embodiment of the camera display system according to the invention in connection with a vehicle according to the invention.

FIGS. 2 and 3 show a view of an embodiment of the vehicle according to the invention from the side or from the rear.

FIGS. 4A to 11B illustrate the adaptation of display results on the basis of embodiments of the operating method according to the invention.

FIG. 12 schematically shows another embodiment of the vehicle according to the invention with focus on the interior thereof and the construction of the display system provided there.

### DETAILED DESCRIPTION OF THE DRAWINGS

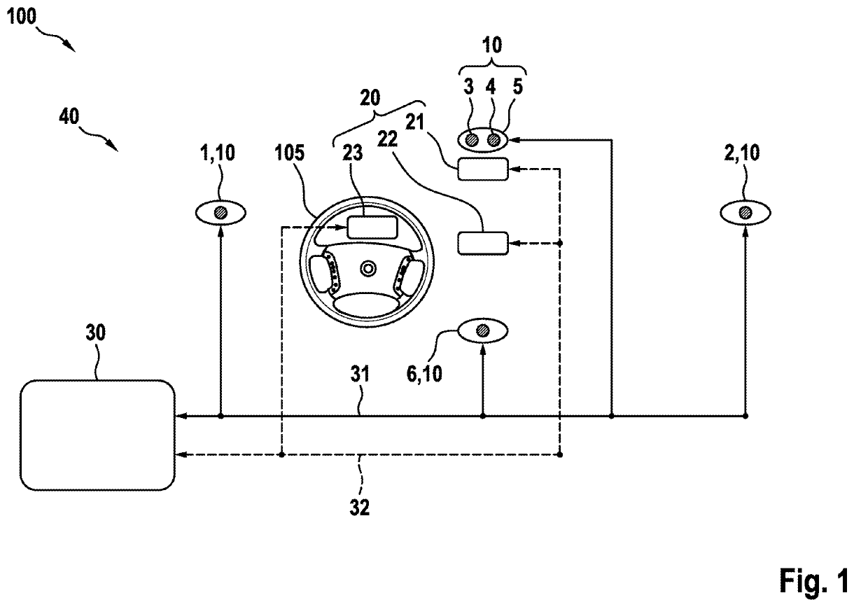

With reference to FIGS. 1 to 12, exemplary embodiments and the technical background of the invention will be described in detail below. Identical and equivalent, and identically or equivalently acting, elements and components have the same reference signs. The detailed description of the relevant elements and components will not be reproduced every time they occur.

The illustrated features and further properties can be isolated from one another in any desired form and combined as desired, without departing from the core of the invention.

FIG. 1 illustrates schematically, in the manner of a block diagram, an embodiment of the camera display system 40 according to the invention in connection with an embodiment of the vehicle 100 according to the invention.

The schematic illustration of FIG. 1 describes, in the manner of a diagram, the construction of a camera display system 40 according to the invention as an embodiment of the vehicle 100 according to the invention.

In accordance with FIG. 1, the camera display system 40 according to the invention consists, as per the core, of a camera system 10, a display system 20, and a capturing and control unit 30.

In the embodiment in accordance with FIG. 1, the camera system 10 consists of a first camera unit 1 in the form of a first or left external mirror camera, a second camera unit 2 in the form of a second or right external mirror camera, a third camera unit 5 in the manner of a stereo camera unit having a first or left camera 3 and a second or right camera 4, and a fourth camera unit 6, which is embodied in the manner of a reversing camera unit with a fisheye camera or a camera having a fisheye lens, and thus offers a wide-angle view.

All camera units and cameras 1 to 6 are operatively connected to the capturing and control unit via a first capturing and control line 31 so as to be controlled or regulated.

The display system 20 consists of a first display unit 21 in the manner of a rearview mirror display or in the manner of a rearview mirror monitor in the spatial region of a rearview mirror which is typically provided in the vehicle 100, a second display unit 22 in the manner of a central console display or in the manner of a central console monitor in the region of a central console 107 of the vehicle 100, and a third display unit 23 in the manner of a dashboard display or in the manner of a dashboard monitor, which is arranged on the side of a steering wheel 105 of the vehicle 100 that faces away from the driver.

The first to third display units 21, 22, and 23 of the display system 20 are operatively connected to the capturing and control unit 30 via a second capturing and control line 32 so as to be controlled or regulated.

The capturing and control unit 30 is configured and set up according to the invention to perform an embodiment of the operating method according to the invention and in particular to ensure that, if an error occurs in one of the camera units 1 to 6, images of the environment of the camera units 1 to 6 are combined into an image without an error and displayed on at least one of the display units 21 to 23.

It is possible in this way that even in the case of a partial or complete failure of one or more of the camera units 1 to 6, a display of images of the environment that is relevant for the reliability of the operation of the vehicle on at least one of the display units 21 to 23 of the display system 20 is possible.

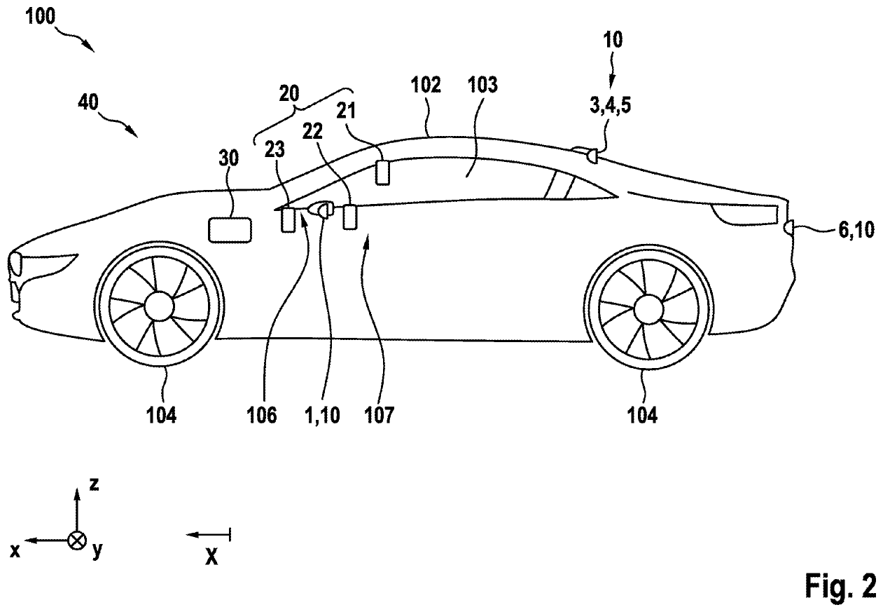

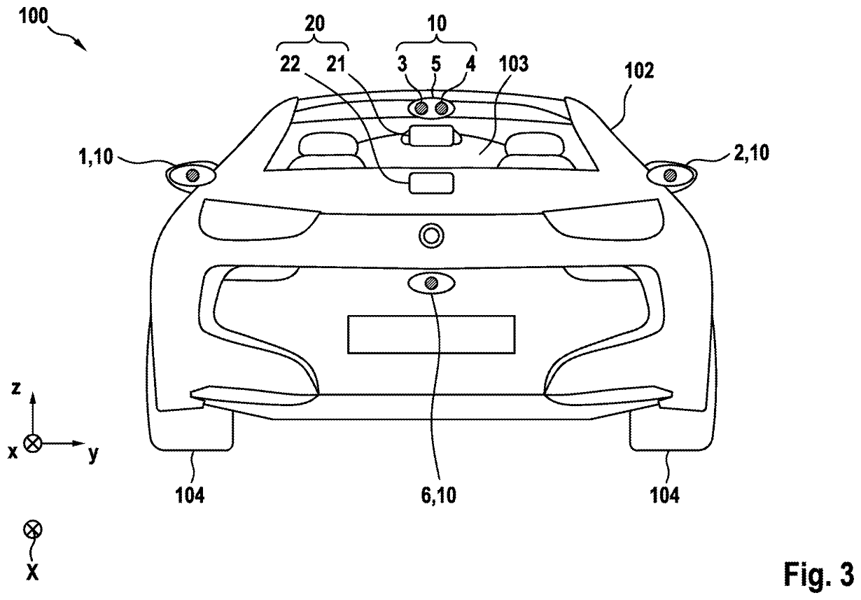

FIGS. 2 and 3 show a view of an embodiment of the vehicle 100 according to the invention from the side or from the rear.

Illustrated here are an embodiment of the camera display system 40 according to the invention and the display system thereof, display units 21 to 23, and the camera system 10 thereof having camera units 1 and 3 to 6.

Furthermore, a capturing and control unit 30 is provided and operatively connected to the display system 20 and the camera system 10 and the components thereof. The corresponding first and second capturing and control lines 31 and 32 are not illustrated explicitly here. As an alternative to such lines, wireless connections are also feasible.

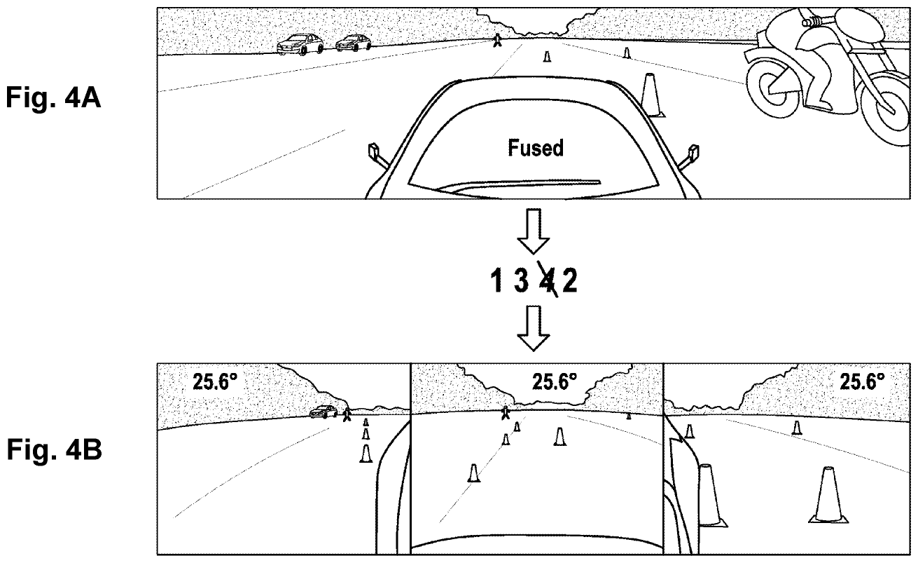

FIGS. 4A to 11B illustrate the adaptation of display results on the basis of embodiments of the operating method according to the invention.

FIGS. 4A to 11B schematically illustrate the management of different error scenarios. These will be briefly outlined below and illustrated in detail further below.

A respective FIG. 4A shows the error-free situation, and FIG. 4B describes the management of the respective error event.

In the situations illustrated by FIGS. 4A to 6B, the presence of a left external mirror camera 1, a right external mirror camera 2 and a stereo camera 5 having a left camera 3 and a right camera 4 is assumed.

In FIGS. 4A, 5A, 6A, the presentation in the error-free event is effected in the manner of a panorama image or fusion image, in each case made of the images of the cameras 1 to 4.

FIG. 4B manages the failure of the right camera 4 of the stereo camera unit 5, specifically by switching to a triptych illustration with the exclusive use of the images of the cameras 1 to 3.

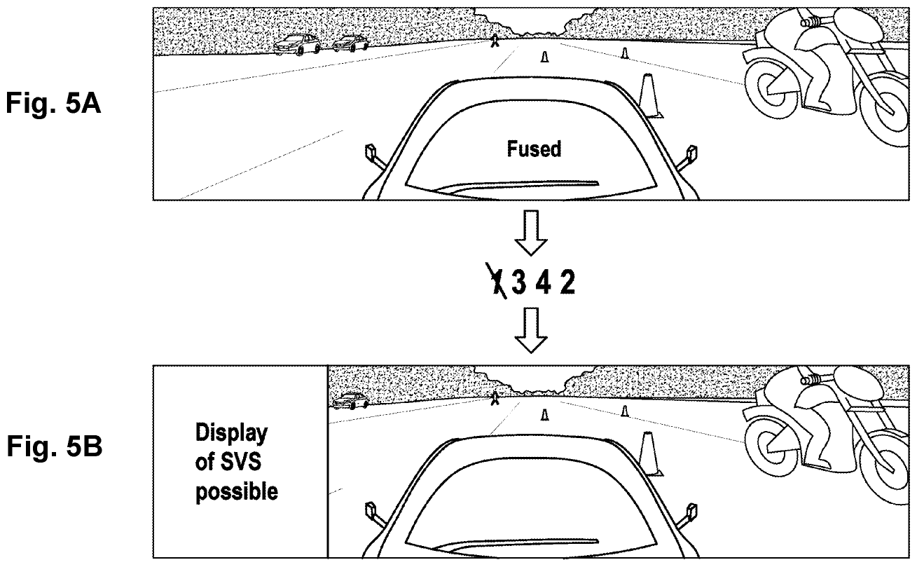

FIG. 5B relates to the failure of the left external mirror camera 1 with a transition to a panorama or fusion presentation with expanded field of view with respect to the images of the cameras 2 to 4.

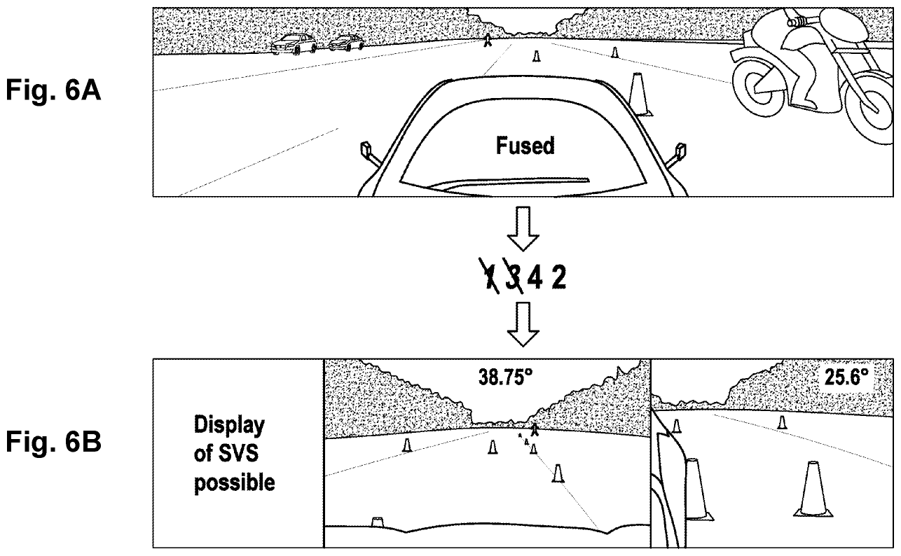

FIG. 6B shows the case that both the left external mirror camera 1 and the left camera 3 of the reversing camera unit 5 have failed, specifically with transition to a diptych with an expanded field of view with respect to the cameras 2 and 4.

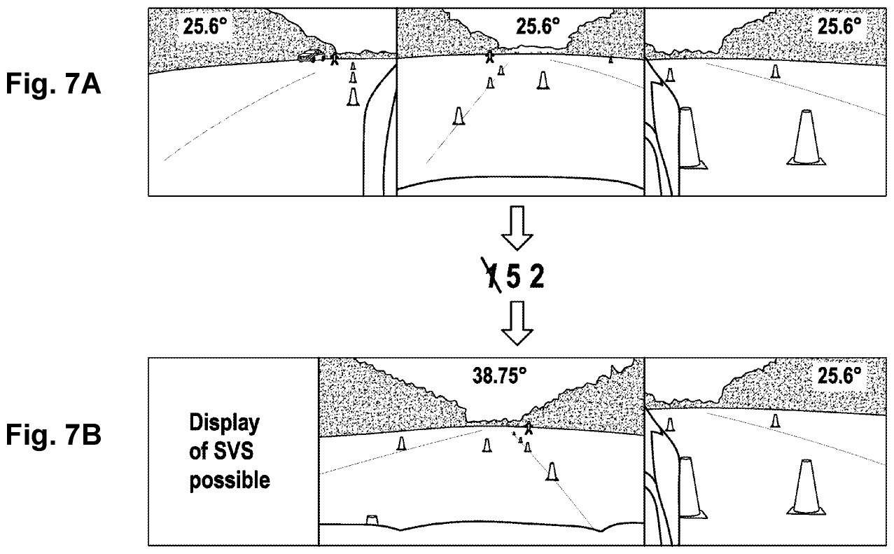

FIGS. 7A to 10B describe a situation in which, in addition to the right and left external mirror cameras 1 and 2, an individual central camera 5 is embodied which does not represent a stereo camera as such. In the error-free case, in each case a combined image presentation in the manner of a triptych is assumed.

FIG. 7B relates to the failure of the left external mirror camera 1 with a transition to a diptych with an expanded field of view, in particular for the central camera 5.

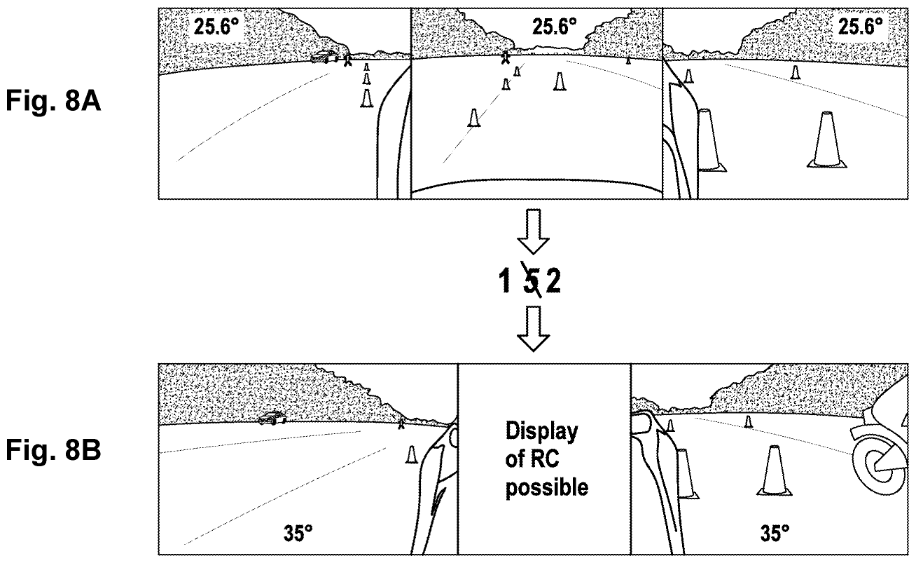

FIG. 8B describes the error event at the central camera 5 with a transition to a separated diptych with an expanded field of view for both external mirror cameras 1 and 2.

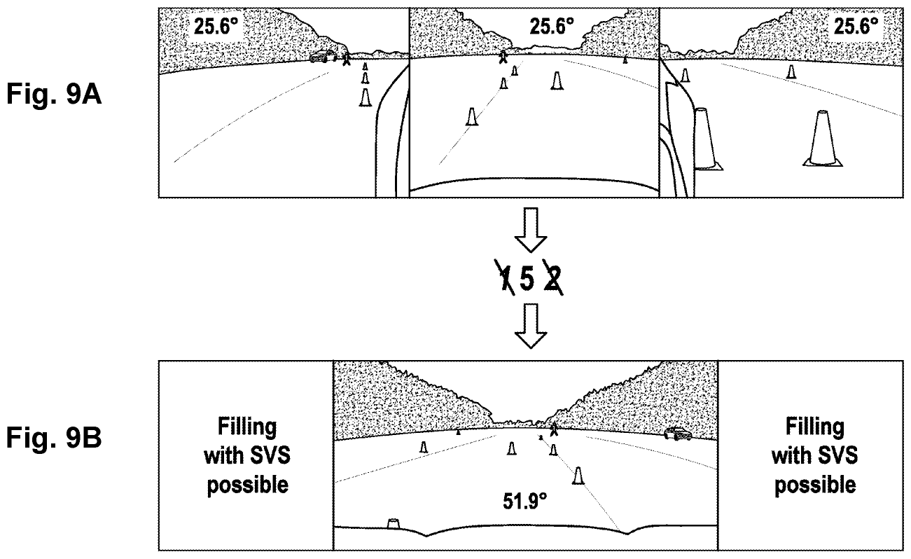

In the situation according to FIG. 9B, the failure of both external mirror cameras 1 and 2 is managed by a transition to an individual view with an expanded field of view for the central camera 5.

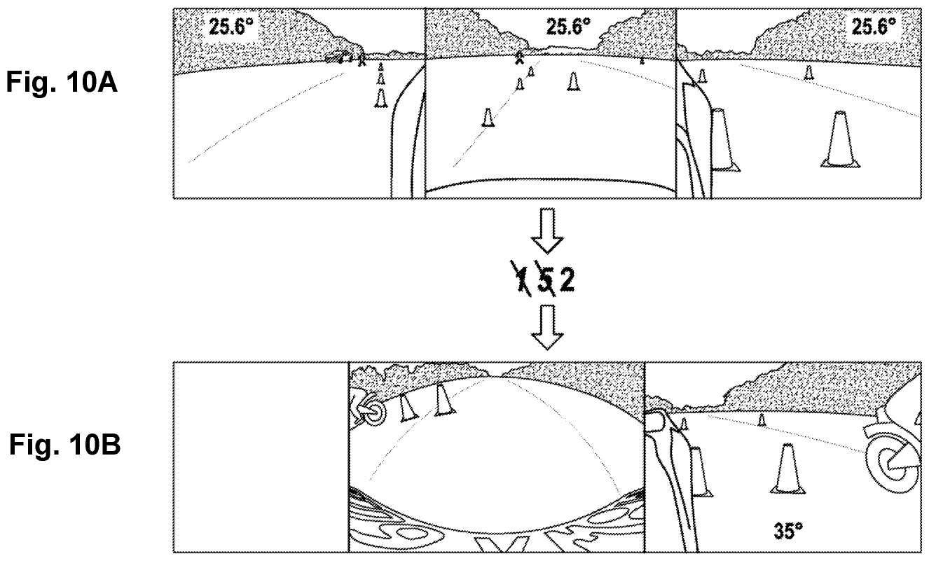

If both the left external mirror camera 1 and the central camera 5 fail, according to FIG. 10B in the presence of an additional reversing camera 6, the situation is displayed in the manner of a diptych, wherein the right external mirror camera 2 and the image of the reversing camera 6 in each case with an expanded field of view contribute.

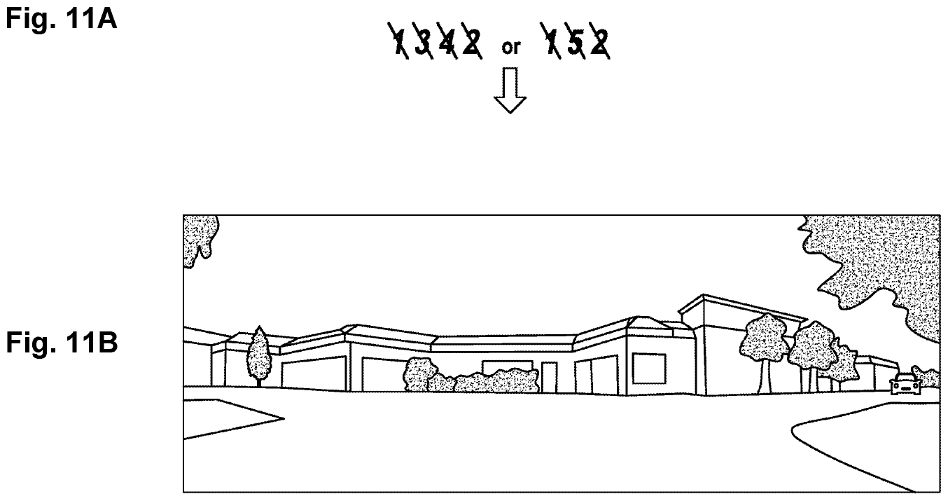

FIG. 11 deals with the case that all regular cameras 1 to 5 have failed, but a reversing camera 6 is embodied, the image of which is then displayed as a panorama image.

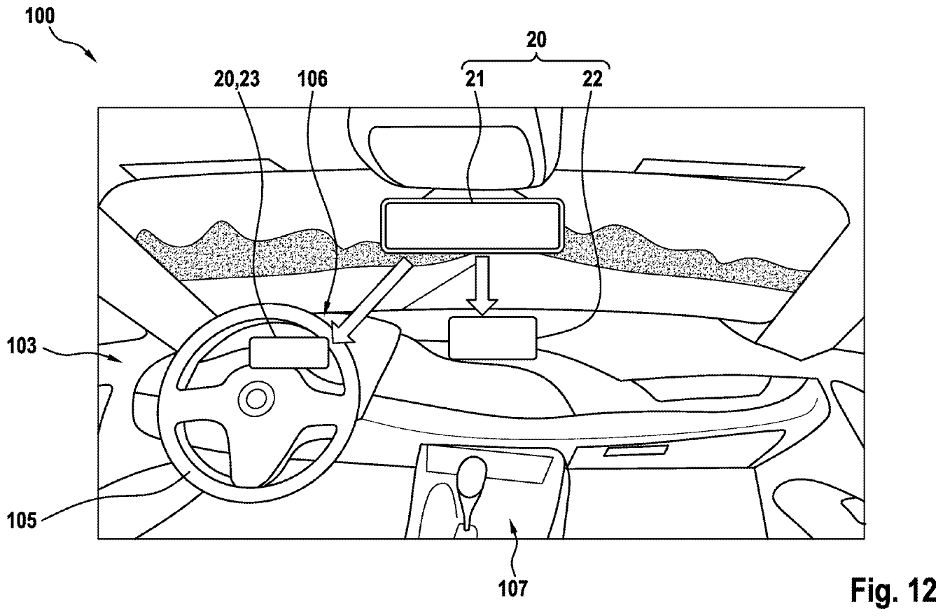

FIG. 12 schematically illustrates another embodiment of the vehicle 100 according to the invention with focus of the interior 103 thereof and the construction of the display system 20 that is provided there.

In the embodiment according to FIG. 12, the display system 20 is embodied with a first display unit 21 in the manner of a reversing mirror monitor. The second display unit 22 is embodied in the manner of a central console display or in the manner of a central console monitor slightly above the central console at the level of the dashboard 106 of the vehicle 100. The third display unit 23 is situated on the side of the steering wheel 105 that is remote from the driver and is embodied in the manner of a dashboard display or in the manner of a dashboard monitor and thus directly in the region of the dashboard 106, for example in overlap with or in the vicinity of the typical speed indication.

In the embodiment according to FIG. 12, the first display unit 21 acts as a primary display unit and consequently supports the observation behavior with respect to the rearview mirror display that is typical for a driver.

In accordance with an embodiment of the operating method according to the invention, if an error occurs in the region of the first display 21, a switch is performed to the second display unit 22 and/or to the third display unit 23.

If all display units one 20 to 23 exhibits an error, optionally an acoustic and/or haptic warning signal may be output that indicates this situation.

These and further features and properties of the present invention will be further explained on the basis of the following statements:

The present invention in particular relates to a motor vehicle 100, which is provided with a plurality of cameras 1 to 6 and is equipped with a computer device 30 for processing the images.

In addition, a method for operating a camera system 10 in a motor vehicle 100 is stated.

The present invention in particular proposes a degradation concept for camera display systems 40.

The degradation concept is to come into force under the following premises:

(a) In the case of an image failure or the loss of large image portions or if soiling is too great, the disturbance is recognized in time by way of the entire operative chain, for example using watchdog software.
(b) The architecture of the electrical system permits alternative signal travel paths.

In order to clarify the full scope of the invention, the concept will now be illustrated on the basis of the cases which have already been described.

Case 1: A failure of a camera 4 of the stereo camera arrangement 5 in the fused image according to FIGS. 4A and 4B. In accordance with the invention, it is possible to change from panorama to triptych with the first stereo camera 3. The notification “image fusion disturbed” may appear.

Case 2: A failure of a camera 1 of the sides in the fused image in accordance with FIGS. 5A and 5B. In accordance with the invention, it is possible to change from panorama to a partially fused image. The rear camera 5 obtains a greater field of view (FOV) on the side exhibiting the failure. The notification “camera failed” may appear. It is possible for a camera restart to be effected, for example with five attempts per minute.

Case 3: A failure of two cameras in the fused image in accordance with FIGS. 6A and 6B. According to the invention, it is possible to switch from panorama to two cameras 2 and 4 in a diptych. A camera restart with five attempts per minute is feasible.

Case 4: A failure of a side camera 1 in the triptych in accordance with FIGS. 7A and 7B. In accordance with the invention, it is possible to switch from panorama to two cameras 2 and 5 in diptych. The rear camera 5 can obtain a greater field of view on the side with the failure. A camera restart with 5 attempts per minute can be effected. It is also conceivable to output a message, for example in accordance with a CCM transmission 914 dec.

Case 5: A failure of the rear camera 5 in the triptych in accordance with FIGS. 8A and 8B. According to the invention, it is possible to switch to an alternative rear camera. If this is not possible, a notification in accordance with CCM 914 dec. is effected. A camera restart with 5 attempts per minute can be performed. The images of the side cameras 1 and 2 are shown proportionately with more field of view. The failure of the central image occurs only if the restart of the second stereo camera does not succeed.

Case 6: A failure of the two side cameras 1 and 2 in the triptych in accordance with FIGS. 9A and 9B. In accordance with the invention, the horizontal opening angle of the remaining camera 5 can open fully. A notification in accordance with CCM transmission 785 dec. “Please stop immediately” is conceivable. A restart of the overall system with 5 attempts per minute can be effected.

Case 7: A failure of a side camera 1 and a stereo camera 5 in the triptych in accordance with FIGS. 10A and 10B. In accordance with the invention, a switch to the reversing camera 6 for the central image can be effected. The image of the side camera 2 is proportionally displayed with more field of view. A notification in accordance with CCM transmission 785 dec. “Please stop immediately” can be output. A restart of the overall system with five attempts per minute is feasible.

Case 8: A failure of all cameras or of the display in accordance with FIG. 11. In accordance with the invention, it is possible to switch to the display of the reversing camera 6 instead of the CMS cameras. This is done with a lower angle resolution, but at least an image forms. A notification in accordance with CCM transmission 785 dec. “Please stop immediately” can be output. Alternatively, a gong or another warning tone may sound. A restart of the overall system with a repetition rate of five per minute can be effected.

Case 9: A failure of the primary display 21, in particular in accordance with FIG. 12. The display on the internal mirror display or on the rearview mirror display 21 has a strong temporal delay or presentation is faulty or no display occurs.

(a) The central information display (CID) is immediately used for display. The head unit is to switch with prio 1 a panel similar to the parking panel and be superimposed on all other contents so that the customer is still able to drive to the repair shop.
(b) If the CID is not available or already has prio 1 notifications, the freely programmable combination display of the driver should be filled as per the format and only with the content of the rearward display. The display of the speed and of the transmission is then effected via the HUD.

Among others, the following advantages arise:

A breakdown is avoided or delayed for a long time over several defects, because at least two out of three devices remain intact for indirect view (in accordance with ECE-R46) and effect display.

The journey to the repair shop can always be made possible, because even after the failure of all CMS cameras and at least one screen, the surround-view cameras, for example within the meaning of a reversing camera 6, continue to make the same field of view possible, even though at lower resolution. Consequently, this multistage degradation concept practically always makes possible the journey to the repair shop, even though a plurality of faults would have already forced a vehicle having mirrors to make an emergency stop (both mirrors off).

### LIST OF REFERENCE SIGNS

1 (first) camera, camera unit, first or left external mirror camera
2 (second) camera, camera unit, second or right external mirror camera
3 camera, camera unit, first or left camera of the stereo camera unit 5
4 camera, camera unit, second or right camera of the stereo camera unit 5
5 (third) camera unit, stereo camera unit
6 (fourth) camera unit, reversing camera unit
10 camera system
20 display system
21 (first) display unit, rearview mirror display or monitor
22 (second) display unit, central console display or monitor
23 (third) display unit, dashboard display or monitor
30 capturing and control unit
31 (first) capturing and control line
32 (second) capturing and control line
40 camera display system
100 vehicle
102 body
103 interior
104 wheel
105 steering wheel
106 dashboard
107 central console
X vehicle longitudinal direction, driving direction
x spatial directions
spatial directions
Y
z spatial directions

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An operating method for a camera display system in a vehicle including a camera system having a plurality of cameras and a display system having a display, the method comprising:
capturing images of an environment with the plurality of cameras, wherein the images of the environment are independent of each other;
displaying the images of the environment as a combined image on the display;
determining an error status of each of the plurality of cameras; and
in a case in which an error occurs in one or more of the plurality of cameras, the images of the environment of cameras without an error are combined into a new combined image and displayed on the display.

2. The operating method according to claim 1, wherein the image of a camera having an error is not, or only partially, taken into account for display.

3. The operating method according to claim 1, wherein at least one of the following is true:
the plurality of cameras is used to capture the images of the environment with a non-restricted or expanded field of view, and
the plurality of cameras is used to capture the images of the environment with a partially overlapping field of view.

4. The operating method according to claim 1, wherein
in an error-free event upon display, the images of the plurality of cameras are displayed in combination in a fusion image or in a polyptych with a number of frames, with a restricted field of view, in the case of overlapping fields of view of the cameras and captured images, and
in a case of an error upon display, the images of the plurality of cameras without errors are displayed in combination in the fusion image or in the polyptych with a correspondingly reduced number of frames, with a non-restricted or an expanded field of view.

5. The operating method according to claim 1, wherein the camera system includes a left external mirror camera, a right external mirror camera, and a centrally arranged third camera, which includes at least one of a stereo camera, including a first left camera and a second right camera, and a reversing camera, used as an auxiliary fisheye camera, wherein each of the plurality of cameras in the camera system has a field of view which is oriented substantially counter to a main driving direction of the vehicle.

6. The operating method according to claim 1, wherein the display includes a plurality of displays, the method further comprising:
determining an error status of each of the plurality of displays;
in a case in which an error occurs in a display of the plurality of displays, displaying the images with a display that is without the error; and
in a case in which the error occurs in all of the plurality of displays, generating and outputting an acoustic warning signal using an audio system of the vehicle.

7. The operating method according to claim 1, wherein the display includes a plurality of displays including a rearview mirror display, a central console display, and a dashboard display.

8. A camera display system in a vehicle, the camera display system comprising:
a camera system including a plurality of cameras;
a display system including a display; and
a capturing and control unit, which is connected to the camera system and the display system via a capturing and control line, configured to capture images of an environment with the plurality of cameras, wherein the images of the environment are independent of each other, display the images of the environment as a combined image on the display, determine an error status of each of the plurality of cameras, and, in a case in which an error occurs in one or more of the plurality of cameras, combines the images of the environment of cameras without an error into a new combined image and displays the new combined image on the display.

9. The camera display system according to claim 8, wherein
the camera system has a left external mirror camera as a first camera, a right external mirror camera as a second camera, and a centrally arranged third camera including at least one of a stereo camera having a first left camera and a second right camera, and a reversing camera as an auxiliary fisheye camera, wherein each of the plurality of cameras in the camera system has a field of view which is oriented substantially counter to a main driving direction of the vehicle, and
the display system includes at least one of a rearview mirror display, a central console display, and a dashboard display.

10. A vehicle comprising a camera display system including a camera system including a plurality of cameras; a display system including a display; and a capturing and control unit, which is connected to the camera system and the display system via a capturing and control line, configured to capture images of an environment with the plurality of cameras, wherein the images of the environment are independent of each other, display the images of the environment as a combined image on the display, determine an error status of each of the plurality of cameras, and, in a case in which an error occurs in one or more of the plurality of cameras, combines the images of the environment of cameras without an error into a new combined image and displays the new combined image on the display.

11. The operating method according to claim 2, wherein at least one of the following is true:
the plurality of cameras is used to capture the images of the environment with a non-restricted or expanded field of view, and
the plurality of cameras is used to capture the images of the environment with a partially overlapping field of view.

12. The operating method according to claim 2, wherein
in an error-free event upon display, the images of the plurality of cameras are displayed in combination in a fusion image or in a polyptych with a number of frames, with a restricted field of view, in the case of overlapping fields of view of the cameras and captured images, and
in a case of an error upon display, the images of the plurality of cameras without errors are displayed in combination in the fusion image or in the polyptych with a correspondingly reduced number of frames, with a non-restricted or an expanded field of view.

13. The operating method according to claim 3, wherein
in an error-free event upon display, the images of the plurality of cameras are displayed in combination in a fusion image or in a polyptych with a number of frames, with a restricted field of view, in the case of overlapping fields of view of the cameras and captured images, and
in a case of an error upon display, the images of the plurality of cameras without errors are displayed in combination in the fusion image or in the polyptych with a correspondingly reduced number of frames, with a non-restricted or an expanded field of view.

14. The operating method according to claim 2, wherein the camera system includes a left external mirror camera, a right external mirror camera, and a centrally arranged third camera, which includes at least one of a stereo camera, including a first left camera and a second right camera, and a reversing camera, used as an auxiliary fisheye camera, wherein each of the plurality of cameras in the camera system has a field of view which is oriented substantially counter to a main driving direction of the vehicle.

15. The operating method according to claim 3, wherein the camera system includes a left external mirror camera, a right external mirror camera, and a centrally arranged third camera, which includes at least one of a stereo camera, including a first left camera and a second right camera, and a reversing camera, used as an auxiliary fisheye camera, wherein each of the plurality of cameras in the camera system has a field of view which is oriented substantially counter to a main driving direction of the vehicle.

16. The operating method according to claim 2, wherein the display includes a plurality of displays, the method further comprising:
determining an error status of each of the plurality of displays;
in a case in which an error occurs in a display of the plurality of displays, displaying the images with a display that is without the error; and
in a case in which the error occurs in all of the plurality of displays, generating and outputting an acoustic warning signal using an audio system of the vehicle.

17. The operating method according to claim 3, wherein the display includes a plurality of displays, the method further comprising:
determining an error status of each of the plurality of displays;
in a case in which an error occurs in a display of the plurality of displays, displaying the images with a display that is without the error; and
in a case in which the error occurs in all of the plurality of displays, generating and outputting an acoustic warning signal using an audio system of the vehicle.

18. The operating method according to claim 2, wherein the display includes a plurality of displays including a rearview mirror display, a central console display, and a dashboard display.

19. The operating method according to claim 3, wherein the display includes a plurality of displays including a rearview mirror display, a central console display, and a dashboard display.

20. The operating method according to claim 4, wherein the display includes a plurality of displays including a rearview mirror display, a central console display, and a dashboard display.
